(19) United States
(12) Patent Application Publication
(10) Pub. No.: US 2025/0062307 A1
(43) Pub. Date: Feb. 20, 2025

(54) ALKALI-METAL ANODE WITH ALLOY COATING APPLIED BY FRICTION

(71) Applicant: William Marsh Rice University, Houston, TX (US)

(72) Inventors: James M. TOUR, Houston, TX (US); Rodrigo Villegas SALVATIERRA, Houston, TX (US); Duy Xuan LUONG, Houston, TX (US)

(73) Assignee: WILLIAM MARSH RICE UNIVERSITY, Houston, TX (US)

(21) Appl. No.: 18/632,529

(22) Filed: Apr. 11, 2024

Related U.S. Application Data
(63) Continuation of application No. 17/061,223, filed on Oct. 1, 2020, now Pat. No. 11,984,576.
(60) Provisional application No. 62/909,062, filed on Oct. 1, 2019.

(51) Int. Cl. H01M 4/04; H01M 4/02; H01M 4/134; H01M 4/1395; H01M 4/36; H01M 4/38; H01M 4/62; H01M 10/052

(52) U.S. Cl. CPC H01M 4/0402; H01M 4/043; H01M 4/134; H01M 4/1395; H01M 4/366; H01M 4/382; H01M 4/628; H01M 10/052; H01M 2004/027

(57) ABSTRACT

An electrochemical cell with a lithium-metal anode that suppresses dendrite formation and can be fabricated using a simple, inexpensive, and solvent-free process. The anode is coated with a layer of disordered nanomaterial, saturated with lithium ions, that suppresses dendrite formation during charging. The dendrite-suppression coating can be applied simply using a dry, abrasive technique in which the lithium-metal anode is alternately abraded to roughen the surface and polished using a polishing powder of a material that alloys with the lithium.

### CROSS-REFERENCE TO RELATED PATENT APPLICATIONS

This application claims priority to U.S. Patent Appl. Ser. No. 62/909,062, filed Oct. 1, 2019, entitled “Alkali-Metal Anode With Alloy Coating Applied By Friction,” which patent application is commonly owned by the owner of the present invention. This patent application is incorporated herein in its entirety.

### GOVERNMENT INTEREST

This invention was made with government support under Grant No. FA9550-14-1-0111, awarded by the United States Department of Defense/Air Force Office of Scientific Research. The United States government has certain rights in the invention.

### TECHNICAL FIELD

The present invention relates to an alkali-metal (such as lithium-metal) anode that suppresses dendrite formation and a process for making same.

### BACKGROUND

An electric battery includes one or more electric cell. Each cell includes a positive terminal (cathode) and a negative terminal (anode) physically separated by an ion conductor (electrolyte). When a cell is discharged to power an external circuit, the anode supplies negative charge carriers (electrons) to the cathode via the external circuit and positive charge carriers (cations) to the cathode via the internal electrolyte. During charging, an external power source drives electrons from the cathode to the anode via the power source and the resultant charge imbalance pulls cations from the cathode to the anode via the electrolyte.

Lithium-ion (Li-ion) batteries store charge in the anode as Li cations (aka Li ions), which are the positive charge carriers that travel to and are stored in the cathode during discharge. Li-ion batteries are rechargeable and ubiquitous in mobile communications devices and electric vehicles due to their high energy density, a lack of memory effect, and low self-discharge rate.

Lithium-metal batteries store charge in the anode as lithium metal. As with lithium-ion batteries, lithium ions are the positive charge carriers that travel to and are stored in the cathode during discharge. Li-metal batteries retain charge for a long time and have superior power density. Applications include implantable medical devices, watches, and calculators. Li-metal batteries are generally not rechargeable, largely because dendrites-whiskers of conductive lithium-can form within the battery during recharge and short the anode to the cathode. Resultant rapid discharge though the cell can overheat the battery, causing rupture and even explosion. There is a strong demand for rechargeable batteries with the power density available from Li-metal batteries that could be met if dendrite formation could be suppressed.

### SUMMARY OF THE INVENTION

In general, in one embodiment, the invention features a method of fabricating an anode having a coating on a surface of an alkali metal. The method includes texturizing the surface of the alkali metal. The method further includes smoothing the texturized surface of the alkali metal by a process that includes (i) applying a material under pressure to the texturized surface of the alkali metal, and (ii) moving the applied material relative to the texturized surface of the alkali metal under pressure to produce a friction. The friction alloys the material with the alkali metal to produce the coating on the surface of the alkali metal.

Implementations of the invention can include one or more of the following features:

The method can further include repeating the texturizing and the smoothing.

The smoothing can thicken the coating.

The material can consist essentially of particles.

The particles can be grouped as a bulk solid.

The material can include at least one form of carbon nanomaterial.

The material can consist primarily of the at least one form of carbon nanomaterial.

The at least one form of carbon nanomaterial can be selected from a group consisting of multi-walled carbon nanotubes, single-walled carbon nanotubes, few-walled carbon nanotubes, graphene nanoribbons, graphene oxide nanoribbons, graphoil, graphene nanoplatelets, graphene, and mixtures thereof.

The material can include phosphorous.

The material can include sulfur.

The material can consist primarily of phosphorous pentasulfide.

The texturizing can include applying an abrasive under pressure to the surface of the

alkali metal and moving the applied abrasive relative to the surface of the alkali metal.

The abrasive can include granules.

The coating can consist primarily of ions of the alkali metal and at least one form of carbon nanomaterial.

In general, in another embodiment, the invention features an electrochemical cell that includes a cathode, an electrolyte adjacent the cathode, and an anode adjacent the electrolyte opposite the cathode. The anode includes an alkali-metal layer to source alkali-metal ions to the electrolyte. The anode further includes a coating between the alkali-metal layer and the electrolyte. The coating includes an agglomerate of disordered nanomaterial saturated with the alkali-metal ions.

Implementations of the invention can include one or more of the following features:

The coating can include particles derived from a material. The particles can be randomly distributed over the alkali-metal layer and saturated with the alkali-metal ions using a process of (i) texturizing a surface of the alkali-metal layer, (ii) applying the material under pressure to the texturized surface of the alkali-metal layer, and (iii) moving the applied material relative to the texturized surface of the alkali-metal layer under pressure to produce a friction. The friction can alloy the material with alkali metal of the alkali-metal layer to produce the coating.

The coating can include physically altered particles derived from the material.

The randomly distributed particles derived from the material can consist predominantly of the alkali-metal ions and carbon.

The randomly distributed particles derived from the material can consist predominantly of the alkali-metal ions, phosphorous, and sulfur.

The electrochemical cell can further include a current collector physically and electrically contacting the alkali-metal layer.

### BRIEF DESCRIPTION OF THE DRAWINGS

FIG. 1A depicts an electrochemical cell with a lithium-metal anode.

FIG. 1B depicts a method of fabricating the anode shown in FIG. 1 in accordance with an embodiment of the present invention.

FIGS. 2A-2C are scanning electron micrographs (SEM) images of a substrate coated on both sides with a lithium layer, which SEM images are at different magnifications.

FIGS. 2D-2F are SEM images of a substrate bearing a texturized lithium layer, which SEM images are at different magnifications.

FIGS. 3A-3C are SEM images of a substrate bearing texturized lithium layer(s) and an incomplete version of a coating, which SEM images are at different magnifications.

FIGS. 3D-3F are SEM images of a substrate bearing texturized lithium layer(s) after consecutive cycles of abrasion and powder spreading, which SEM images are at different magnifications.

FIG. 4 is an SEM image showing a cross section of a lithium layer bearing a coating formed by application of phosphorus pentasulfide particles using the method detailed in connection with FIG. 1B.

FIG. 5A is an SEM image of an MWCNT-coated Li metal foil produced by a method detailed in connection with FIG. 1B in which a coating over lithium metal was produced by repeating the abrasion and MWCNT powder spreading processes five times.

FIGS. 5B-5D higher magnification SEM images of the MWCNT-coating shown in FIG. 5A.

FIGS. 6A-6D depict cross-sectional SEM images after an initial spreading of MWCNT powder over a textured lithium surface.

FIGS. 7A-7B are SEM images showing cross sections of the interior of an MWCNT-based coating, applied by the abrasion method detailed in connection with FIG. 1B.

FIG. 8 depicts an electrochemical cell having a two-sided variant of battery shown in FIG. 1A.

### DETAILED DESCRIPTION

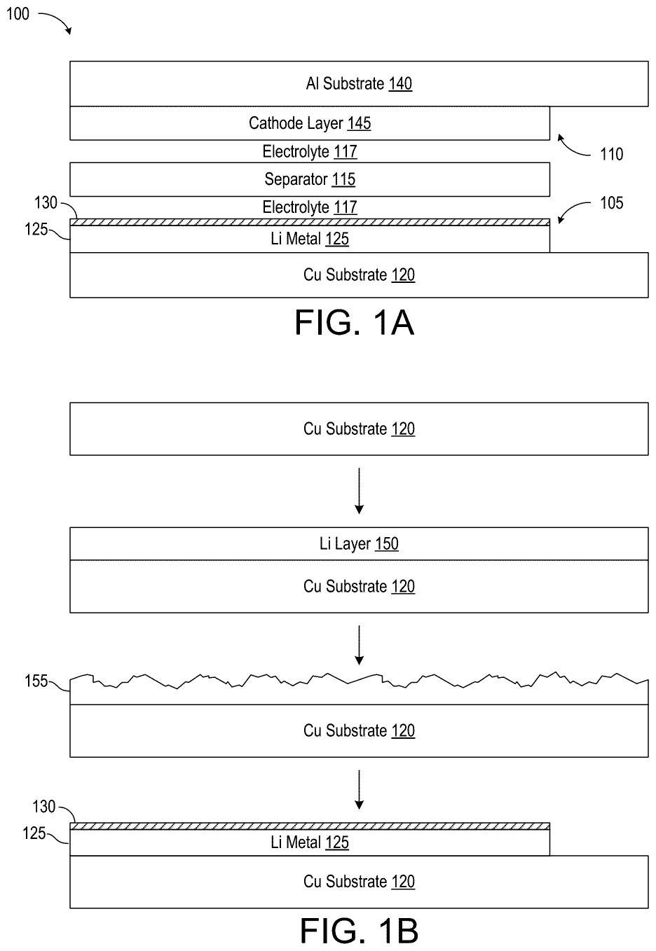

FIG. 1A depicts an electrochemical cell 100 with a lithium-metal anode 105 that suppresses dendrite formation and can be fabricated using a simple, inexpensive, and solvent-free process. As is typical of lithium-metal cells, cell 100 also includes a cathode 110 separated from anode 105 via a separator 115 of, e.g., a porous polymer and an electrolyte 117.

Anode 105 includes a copper substrate 120 that serves as current collector and provides physical support for a layer of lithium metal 125 that sources alkali-metal ions to cathode 110 via electrolyte 117 and separator 115. (Separator 115 is saturated with electrolyte 117 but the two are shown separately for ease of illustration.) A thin-film coating 130 includes an agglomerate of disordered nanomaterial saturated with the alkali-metal ions. Coating 130 suppresses dendrite formation and can be applied simply using a dry, abrasive technique. Cathode 110 includes an aluminum substrate 140 that serves as current collector and provides physical support for an active cathode layer 145. An embodiment of cathode 110 is detailed in 17/009,530, entitled “Sulfurized Carbon Cathodes,” filed Sep. 1, 2020, by Tour et al. (the “Tour ‘530 Patent Application”), which claims priority to U.S. Patent Application Nos. 62/905,125 and 62/905,535, filed Sep. 24, 2019, and Sep. 25, 2019, respectively. The Tour ‘530 Patent Application is incorporated herein by reference. This writing takes precedence over incorporated material, including Tour ‘530 Patent Application, for purposes of claim construction.

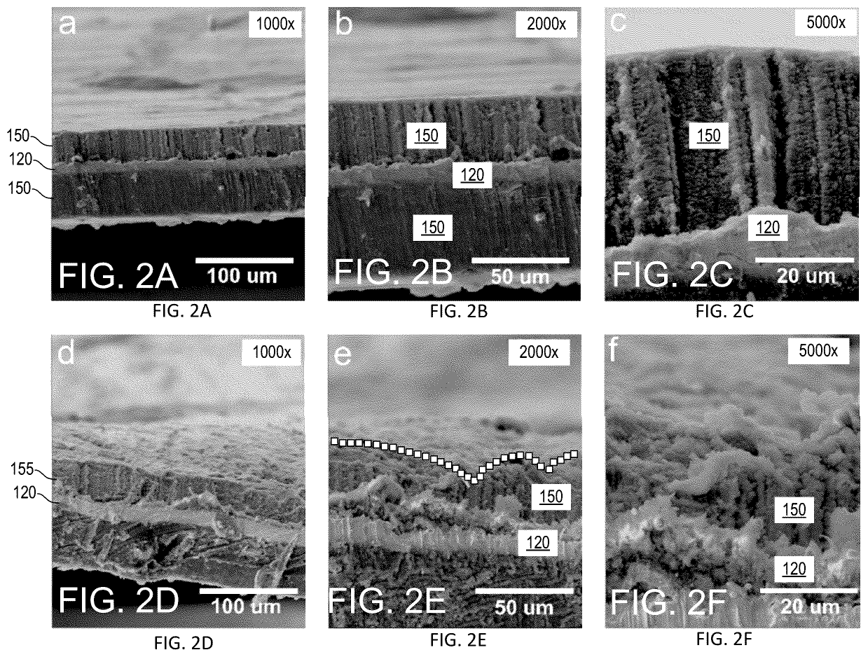

FIG. 1B illustrates a method of fabricating anode 105 of FIG. 1A in accordance with one embodiment. Substrate 120, e.g., a sheet of copper foil 8 μm thick, is coated with, e.g., 40 μm of lithium to form a lithium layer 150. A second lithium layer 150 is formed on the other side of substrate 120 but is omitted in this illustration. FIGS. 2A-2C are scanning electron micrographs (SEMs) of substrate 120 coated on both sides with a lithium layer 150 at, respectively, 1,000×, 2,000×, and 5,000× magnifications. The visible edge was cut with scissors. The copper foil of substrate 120 is slightly deformed due to the cutting. The visible surface of the top lithium layer 150 is smooth with no callosities.

Returning to FIG. 1B, the top surface of lithium layer 150 is texturized by abrasion using, e.g., sandpaper to form a texturized lithium layer 155. FIGS. 2D-2F are SEMs of substrate 120 bearing texturized lithium layer(s) 155 at, respectively, 1,000×, 2,000×, and 5,000× magnifications. The sandpaper was applied by hand using straight movements over the metal surface to produce lines that parallel the reader's view. The abrasion was performed before the material was cut with scissors to expose the imaged edge.

Returning again to FIG. 1B, a polishing powder of M-grade multi-wall carbon nanotubes (MWCNTs) was spread over the texturized surface of layer 155 by hand. Moving the applied material relative to the texturized surface of lithium metal layer 155 under pressure produces a friction that alloys material of the polishing powder with the lithium to produce coating 130. The abrading and polishing steps can be repeated with the same or different abrasives and powders to build coating 130 to a desired thickness. Rubbing with the powder smooths the surface of lithium metal layer 125 and fixes the MWCNTs to that surface as a solid layer (e.g., a bulk solid, an assembly of particles for which the statistical mean of any property is independent of the number of particles).

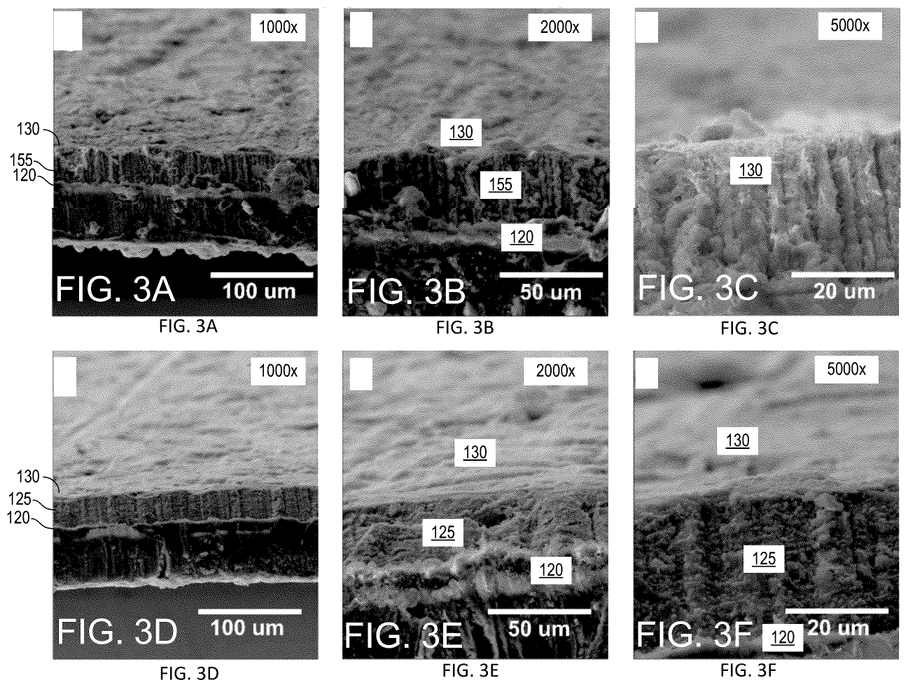

FIGS. 3A-3C are SEMs of substrate 120 bearing texturized lithium layer(s) 155 and an incomplete version of coating 130 at, respectively, 1,000×, 2,000×, and 5,000× magnifications. Lithium is a soft metal and the pressure applied in distributing the MWCNTs may cause the metal to spread into a flat, and possibly thinner, layer.

FIGS. 3D-3F are SEMs of substrate 120 bearing texturized lithium layer(s) 155 after consecutive cycles of abrasion and powder spreading as detailed previously. The upper surfaces of lithium layer 125 and coating 130 appear relatively smooth, with repeated smoothing from the spreading of the powder thickening coating 130.

Both the texturing and material-application processes can be automated for mass production. These processes do not require drying, and can thus be performed quickly and without the areal requirements of wet processes. Unconsumed feed materials, MWCNT powder for example, can be reapplied to minimized waste.

The material used to polish and alloy with layer 125 is not limited to MWCNTs. Other forms of carbon might also be used, such as single-walled carbon nanotubes, few-walled carbon nanotubes, graphene nanoribbons, graphene oxide nanoribbons, graphoil, graphene nanoplatelets, and mixtures thereof. Nor is carbon a prerequisite. For example, some embodiments employ phosphorus pentasulfide (P₄S₁₀), molybdenum disulfide (MoS₂), or both with or in lieu of carbon-based materials. Other materials for use in coating the lithium metal include polyaniline, sulfurized carbon, polytetrafluoroethylene, and polyvinylidene difluoride. Graphene nanomaterials, such as nanoplatelets, can be added to produce more even distribution of the powder materials over the surface of Li metal.

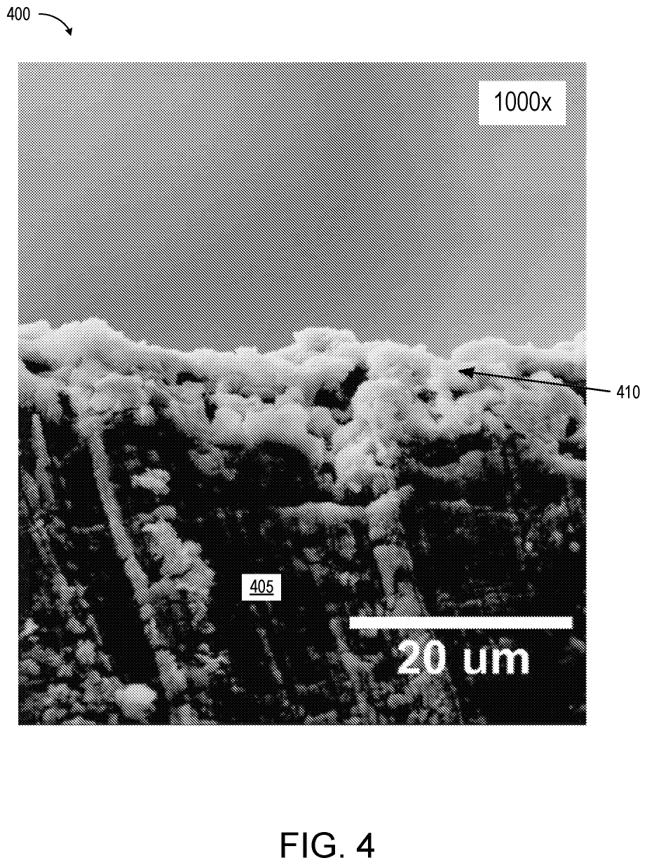

FIG. 4 is a SEM 400 showing a cross section, at 1,000× magnification, of a lithium layer 405 bearing a coating 410 formed by application of phosphorus pentasulfide particles using the method detailed above in connection with FIG. 1B.

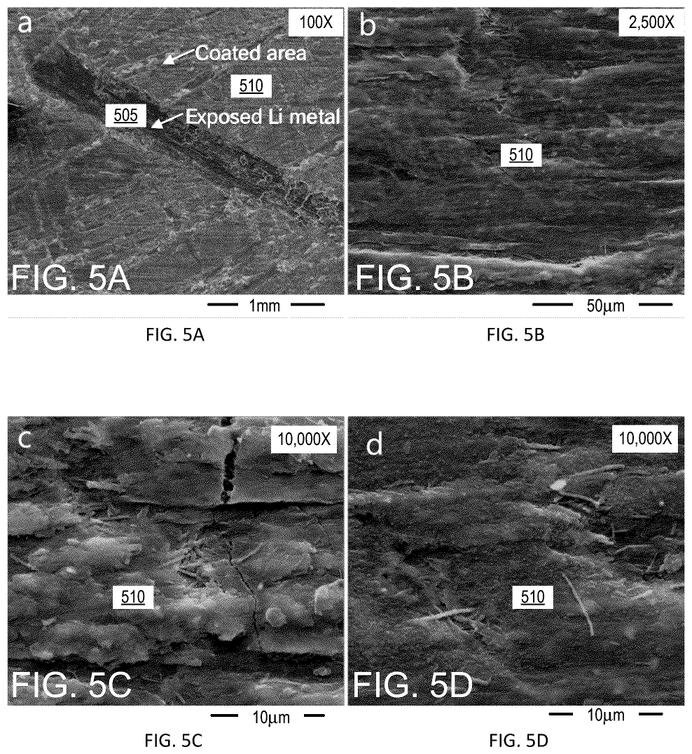

FIG. 5A is a SEM of an MWCNT-coated Li metal foil produced by a method of the type disclosed above in connection with FIG. 1B in which a coating over lithium metal was produced by repeating the abrasion and MWCNT powder spreading processes five times. FIGS. 5B-5D are higher-magnification SEMs of the MWCNT coating.

Though not evident in these black-and-white micrographs, MWCNT coatings produced by the abrasion method can have a reddish/purple hue. A scratch 505 exposing bare lithium-metal was purposefully drawn by a tweezer tip to highlight the coating 510. Coating 510 is an agglomerate of disordered nanomaterial saturated with lithium-metal ions. In an assembled cell, coating 510 separates the lithium metal from the electrolyte and suppresses the formation of dendrites. The surface of coating 510 appears homogenous and few tubular structures (MWCNTs) are seen distributed and intertwined inside the coating. Surface MWCNTs in FIGS. 5C-5D appear to be merged with coating 510.

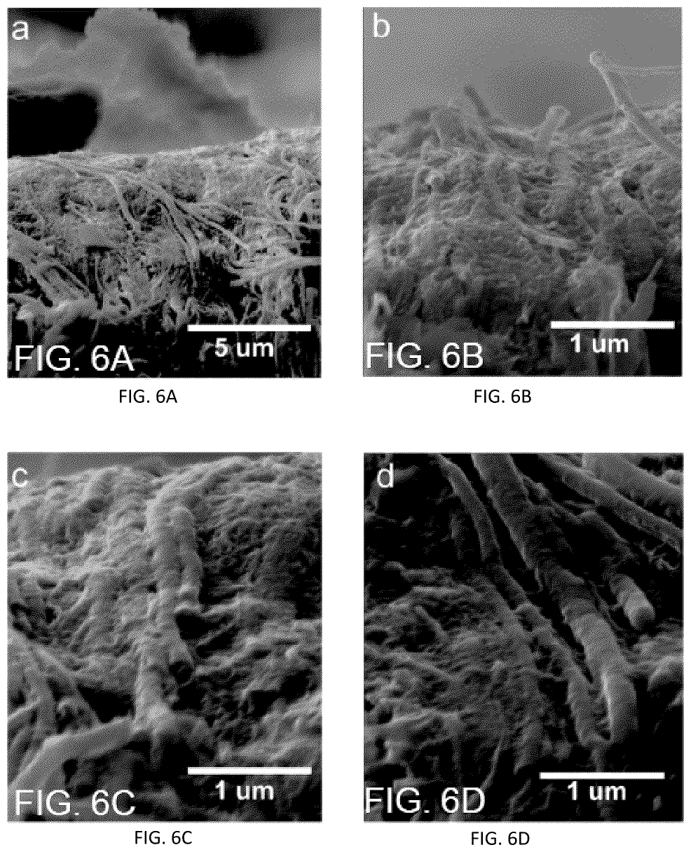

FIGS. 6A-6D show cross-sectional SEMS after an initial spreading of MWCNT powder over a textured lithium surface. At relatively low magnification (FIG. 6A) one can see MWCNTs filling the gaps on top of the Li metal. At higher magnification (FIGS. 6B-6D), tubular structures look damaged at external walls and merged with a material distributed along the surface. In some cases, individual carbon nanotubes (FIGS. 6B-6C) merge into a monolithic structure where it is not easy to distinguish each tube. This initial morphology is what could later (after successive abrasive/spreading cycles) turn into the coating observed in FIGS. 5A-5D.

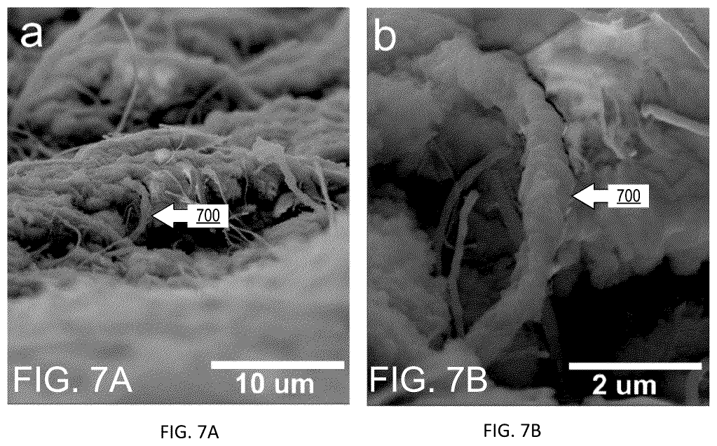

FIGS. 7A-7B are SEMs showing cross sections of the interior of an MWCNT-based coating, applied by the abrasion method of FIG. 1B, in which a tubular structure 700 is seen merging into a bigger monolithic structure, the alloyed coating like coating 130 of FIG. 1A. Structure 700 is evidently a deformed and lithiated carbon nanotube with an irregular surface. Typically, surfaces of MWCNT are seen in SEMs to be smooth and clean. Based on information and belief, the physical deformation of the MWCNT results from the uptake of Li ions and the mechanical damage imposed by the abrasion action.

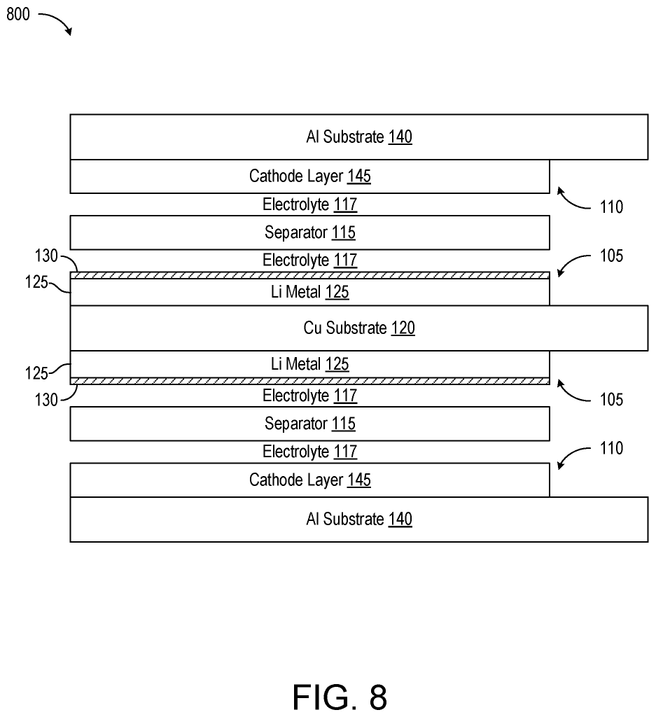

FIG. 8 depicts an electrochemical cell 800, a two-sided variant of cell 100 of FIG. 1A with like-identified elements being the same or similar.

The foregoing discussion focuses on batteries that employ lithium ions as charge carriers. Other alkali metals (e.g., sodium and potassium) and alkali earth metals (e.g., magnesium) can also be used.

Further forms of carbon materials that can be used in addition or alternative to multi-walled carbon nanotubes (and single-walled carbon nanotubes, few-walled carbon nanotubes, graphene nanoribbons, graphene oxide nanoribbons, graphoil, graphene nanoplatelets, and mixtures thereof) include doped MWCNT, reduced graphene oxide, graphene, and mixtures thereof.

Additional variations of these embodiments will be obvious to those of ordinary skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1-20. (canceled)

21. A method comprising:
(a) applying a material under pressure to a surface of an alkali metal; and
(b) moving the applied material relative to the surface of the alkali metal under pressure to produce a friction that alloys the material with the alkali metal and produces a coating on the surface of the alkali metal.

22. The method of claim 21, further comprising texturing the surface of the alkali metal before applying the material under pressure to the surface of the alkali metal.

23. The method of claim 22, further comprising repeating the texturizing and the moving of the applied material relative to the surface of the alkali metal under pressure.

24. The method of claim 23, wherein the repeating thickens the coating.

25. The method of claim 1, wherein the material consists essentially of particles.

26. The method of claim 21, wherein the material comprises at least one form of carbon nanomaterial.

27. The method of claim 26, wherein the at least one form of carbon nanomaterial is selected from a group consisting of multi-walled carbon nanotubes, single-walled carbon nanotubes, few-walled carbon nanotubes, graphene nanoribbons, graphene oxide nanoribbons, graphoil, graphene nanoplatelets, graphene, and mixtures thereof.

28. The method of claim 21, wherein the material comprises at least one of phosphorus and sulfur.

29. The method of claim 21, further comprising combining the coating on the alkali metal with a cathode and an electrolyte to form an electrochemical cell.

30. An electrochemical cell comprising:
(a) an anode having
(i) a layer of an alkali metal, and
(ii) a coating, directly on the layer of the alkali metal, of an alloy of the alkali metal and a disordered nanomaterial;
(b) an electrolyte adjacent and in contact with the coating; and
(c) a cathode adjacent and in contact with the electrolyte.

31. The electrochemical cell of claim 30, wherein the coating is a bulk solid.

32. The electrochemical cell of claim 30, wherein the cathode lacks ions of the alkali metal.

33. The electrochemical cell of claim 32, wherein the cathode comprises sulfurized carbon.

34. The electrochemical cell of claim 30, wherein the disordered nanomaterial includes particles randomly distributed in the coating and saturated with ions of the alkali metal using a process of applying the nanomaterial under pressure to the layer of the alkali metal and moving the applied nanomaterial relative to the layer of the alkali metal to produce a friction that alloys the nanomaterial with the alkali metal.

35. The electrochemical cell of claim 34, wherein the coating comprises physically altered particles derived from larger nanomaterial.

36. The electrochemical cell of claim 30 further comprising a current collector physically and electrically contacting the alkali metal.

37. The electrochemical cell of claim 30, wherein the nanomaterial consists essentially of carbon.

38. The electrochemical cell of claim 30, the anode further comprising a copper current collector.
